(19) United States
(12) Patent Application Publication
(10) Pub. No.: US 2009/0297673 A1
(43) Pub. Date: Dec. 3, 2009

(54) Packaging Box for Packaging, Preserving, Microwave Steam Cooking and Consumption of Foods

(76) Inventors: Alain Sebban, Ecully (FR); Claude Sebban, Lyon (FR)

Correspondence Address: CLARK & BRODY, 1090 VERMONT AVENUE, NW, SUITE 250, WASHINGTON, DC, 20005, US

(21) Appl. No.: 11/988,297

(22) PCT Filed: Jul. 4, 2006
(86) PCT No.: PCT/FR2006/050675

§ 371 Date: Jul. 7, 2009

(30) Foreign Application Priority Data
Jul. 5, 2005 (FR) 0507122
Jan. 27, 2006 (FR) 0600747

(51) Int. Cl. B65D 81/34; H05B 6/80; A23L 1/16

(52) U.S. Cl. 426/107; 219/731

(57) ABSTRACT

This present invention concerns a receptacle (1) made from a material that allows the passage of microwaves and that is intended to accommodate a food preparation (5) which has to undergo a final stage of steam cooking in a microwave oven, where this receptacle (1) includes a peripheral wall (2) and a bottom forming an internal volume, characterised in that the bottom of the receptacle is unperforated and includes a cavity which is (6) intended to accommodate a liquid reserve, and in that the peripheral wall (2) of the receptacle (1) is equipped with a series of channels for the diffusion (9) of steam generated from the liquid during the cooking stage in a microwave oven, with the said diffusion channels (9) being connected to the cavity (6) and to the internal volume of the receptacle (1).

This present invention concerns the technical field of packaging and cooking of food products. In particular, the subject of this present invention is a new receptacle that is suitable for the cooking of a food preparation in a microwave oven, and in particular of food pasta, with a pack and a prepared food product employing such a receptacle.

In order to meet the needs of certain consumers who wish to be able to consume hot and tasty dishes without losing time, a market has developed for pre-cooked meals and fast food services.

Document FR 2 860 213, in the name of the applicants, describes a disposable pack for a food preparation that is intended to undergo a final stage of steam cooking or steaming in a microwave oven, and which includes a first isothermal or insulated receptacle, in expanded polystyrene in particular, inside of which a second receptacle, intended to accommodate the food preparation, is placed. To allow satisfactory cooking in a microwave oven, the bottom of the second receptacle is held at some distance from the bottom of the first receptacle, with the bottom of the first receptacle being intended to accommodate a store of water, with the walls and/or the bottom of the second receptacle being perforated to allow the diffusion of steam inside the food preparation as it is cooked by the microwaves.

In practice, it has been observed that this pack does not allow the consumer to handle the pack without burning himself or herself, when the food preparation has just been heated by the microwaves. In fact the generated steam diffuses within the space between the walls of the two receptacles, and the first receptacle is therefore unable to provide adequate thermal insulation.

Moreover, since the expanded polystyrene is a material that is permeable to air, the food preparation cannot be preserved in a modified atmosphere, which is advantageous in the case of fresh products in particular.

One of the objectives of this present invention is precisely to overcome the disadvantages of the packs of the prior art, and to propose a new receptacle that is intended to accommodate a food preparation, which when associated with an external envelope to constitute a pack, results in improved handling of the pack when the food preparation that it contains is hot and therefore ready to be consumed.

In this context, the subject of this present invention is a new receptacle that is intended to accommodate a food preparation that has to undergo a final stage of steam cooking in a microwave oven. This receptacle, with a peripheral wall and a bottom forming an internal volume, is made from a material that allows passage of the microwaves and is characterised in that the bottom of the receptacle, is unperforated, and includes a cavity which is intended to accommodate a liquid reserve and, in that the peripheral wall of the receptacle is equipped with a series of channels for diffusion of the generated steam from the liquid during the process of cooking in a microwave oven, with the said diffusion channels being connected to the cavity and to the internal volume of the receptacle.

Another objective of the invention is to supply an inexpensive disposable pack that is suitable for packaging, preservation in cool or frozen conditions in particular, for steaming in a microwave oven, and finally for the consumption of foodstuffs. This pack is intended in particular for food preparations composed of pre-prepared, partially cooked foodstuffs that have to undergo a final steaming stage in a microwave oven.

As a consequence, the pack according to the invention must firstly allow packaging of the food preparation in a clean and easy manner.

Then the pack according to the invention must allow the preservation and storage of the food preparation, and therefore its stacking in particular.

The pack according to the invention must also allow final cooking of the food preparation in steam, in a microwave oven.

Finally, the food preparation must be capable of being consumed directly from the pack, which constitutes a receptacle that is easy to handle, without the need to transfer the prepared food from one receptacle to another.

The subject of this present invention also includes a disposable pack for a food preparation that is intended to undergo a final stage of steam cooking in a microwave oven, and that includes:
a receptacle as described above,
an external envelope placed around the peripheral wall of the receptacle, and acting as a thermal barrier.

According to another of its aspects, the subject of this present invention also includes a food product which includes a food preparation that is intended to undergo a final stage of steam cooking in a microwave oven, packaged, preferably hermetically, for preservation in cool or frozen conditions, in a pack according to the invention, with the said preparation being placed inside the receptacle, and a liquid reserve being placed in a cavity provided for this purpose and created in the receptacle.

Various other characteristics of the invention will emerge from the description that follows, with reference to the appended figures illustrating methods that can be used for the implementation of the invention.

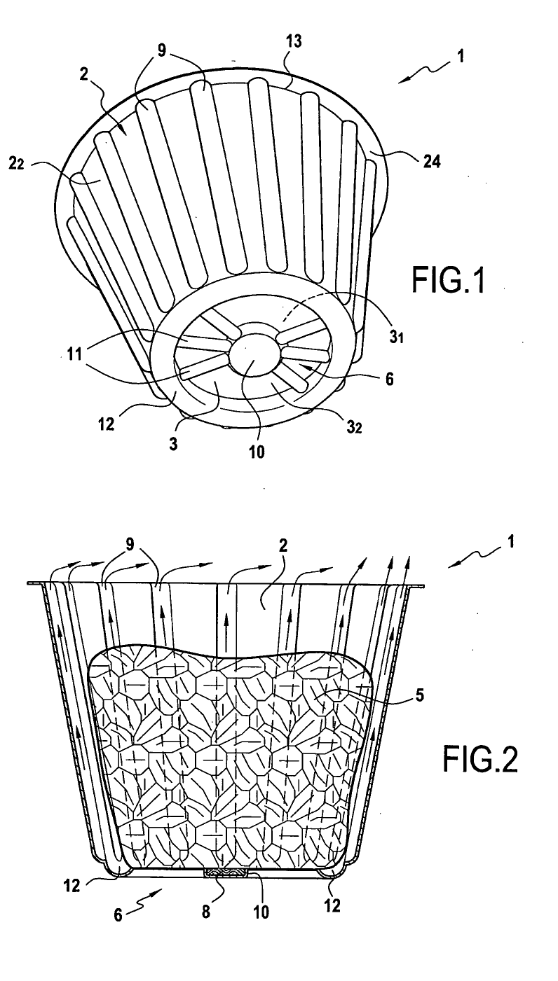

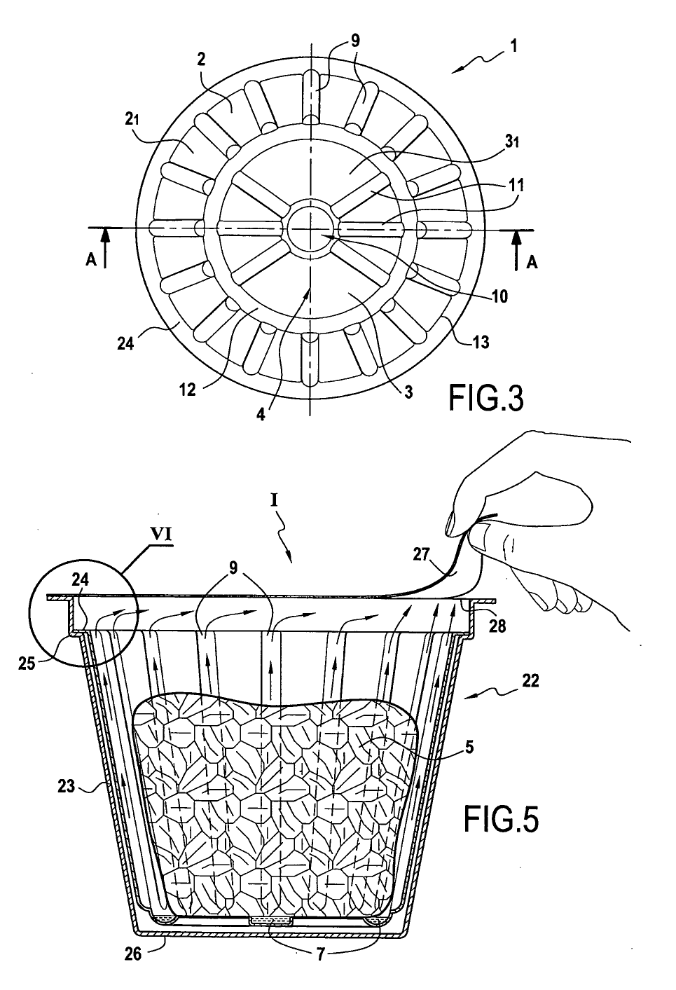

FIGS. 1 and 3 are respectively a view in perspective and a view from above of an example of a receptacle according to the invention.

FIG. 2 is a view in section, on plane A-A, of a receptacle according to FIGS. 1 and 3, which includes a food preparation and a liquid reserve, and highlighting the diffusion of the generated steam.

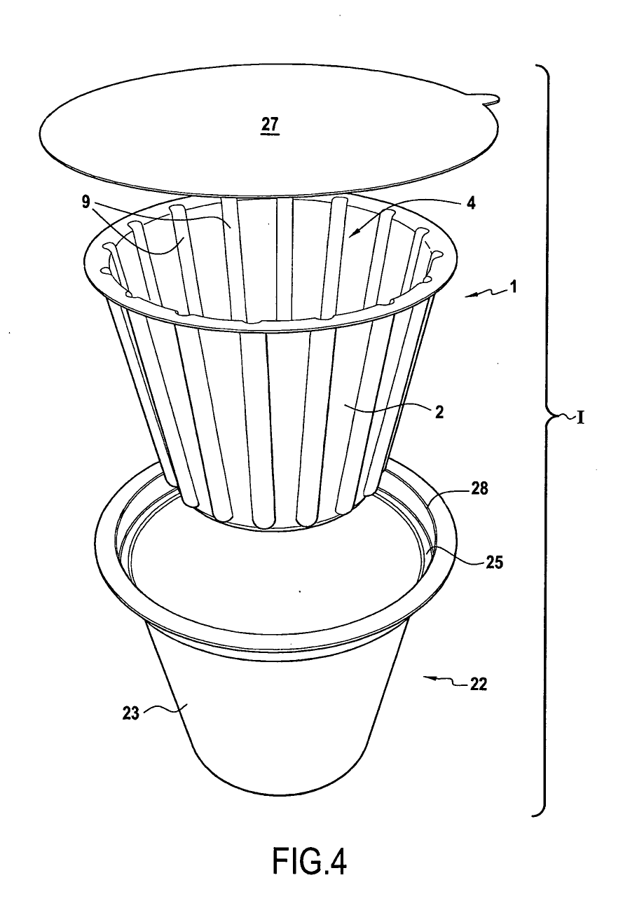

FIG. 4 is a view in perspective of the different elements of a pack according to the invention.

FIG. 5 is a view in section of a prepared food product in a pack according to FIG. 4.

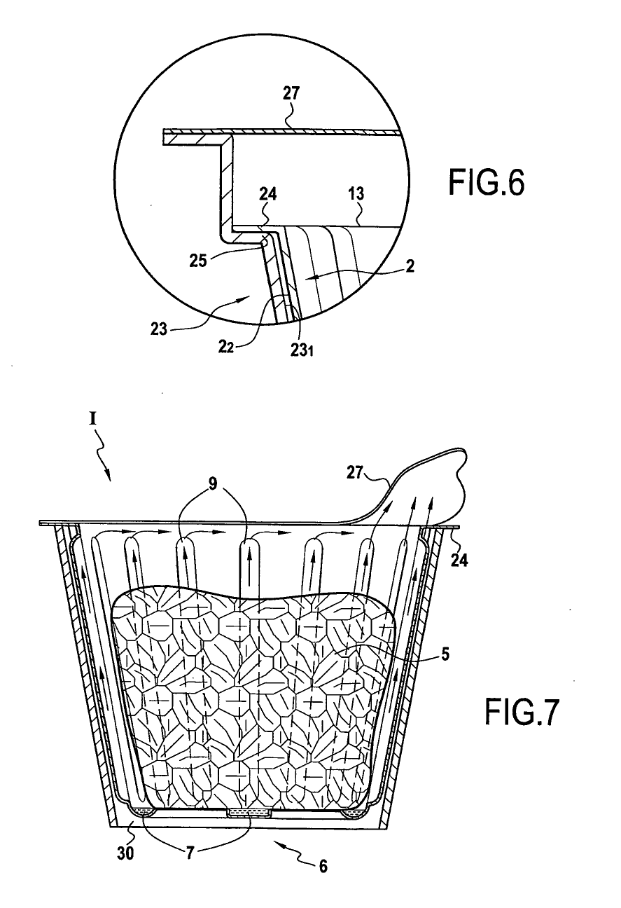

FIG. 6 is a partial view of FIG. 5 deliberately enlarged in order to highlight a part of the pack according to the invention.

FIG. 7 is a view in section similar to FIG. 5 of another variant of a food product according to the invention.

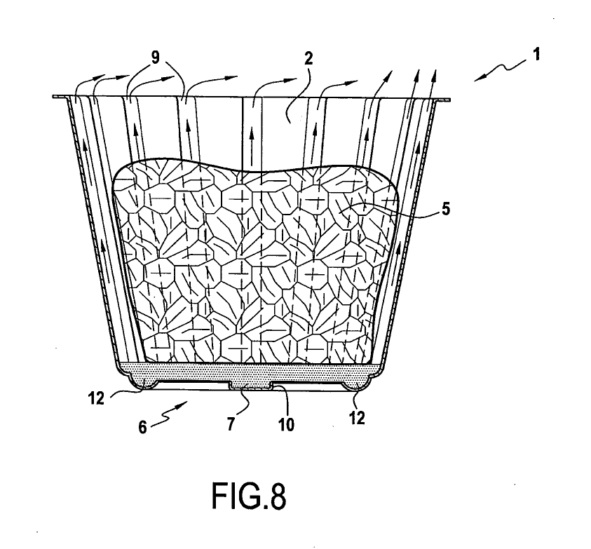

FIG. 8 is a view, similar to FIG. 2, representing another embodiment of the invention.

As illustrated in FIG. 1, the receptacle 1 includes a peripheral wall 2 and a bottom 3, which form an internal volume 4. The receptacle 1 is intended to accommodate a food preparation 5 that will be placed in the internal volume 4. The receptacle 1 can be similar to a tub or an open bowl.

The receptacle 1 is equipped with at least one cavity 6 intended to accommodate a liquid reserve 7, such as water or flavoured water. In fact the food preparation 5, for which the receptacle 1 is designed, is intended to undergo a final steam-cooking stage in a microwave oven. To allow this steaming, arrangements are made to place a liquid reserve 7, and water in particular, inside the receptacle 1. In particular, this store of water can take the form of a sponge 8 saturated with water as illustrated in FIG. 2 or can come in the form of a quantity of possibly frozen water. This water can also be flavoured or scented, with an infusion of oregano (marjoram) for example, to flavour the food preparation as it is cooking. The liquid employed can also be of thicker consistency, like a sauce. In this case, this sauce will preferably contain 30 to 60% of water. In this present description, the percentages given are percentages by weight, meaning that the weight of water represents 30 to 60% of the total weight of the sauce placed at the bottom of the receptacle 1. This aspect of the invention, relating to the food preparation contained in the receptacle, will be described in greater detail later in this document.

The cavity 6 is associated with diffusion channels 9 for the steam that will be generated from the liquid during the cooking stage in a microwave oven. The said diffusion channels 9 are connected to the cavity 6 and to the internal volume 4 of the receptacle 1, as illustrated in FIGS. 1 and 3 and will therefore allow the steam generated during cooking to circulate and to penetrate inside the food preparation 5 then located in the internal volume 4. These diffusion channels 9 will therefore allow the generated steam to spread throughout the internal volume 4 of the receptacle 1, thus allowing even cooking of the food preparation 5 placed therein.

The cavity 6 is advantageously located at the bottom 3 of the receptacle 1. As illustrated in FIG. 1, the cavity 6 is created on the inner face 3₁ of the bottom 3 of the receptacle 1. It therefore constitutes a strengthening element on the inner face 3₁, so as to be open onto the internal volume 4 of the receptacle 1. Still in the example illustrated in FIG. 1 and 2, the wall 2 of the receptacle 1 is equipped with diffusion channels 9 for the steam generated during the cooking stage, from the liquid in particular. The diffusion channels 9 take the form of grooves for example, created on the inner face 2₁ of the peripheral wall 2.

These diffusion channels 9 are connected to the cavity 6 by any appropriate means of connection. In the example illustrated, and as highlighted in FIGS. 1 and 3, the cavity 6 is composed of a central circular cavity 10 connected by channels 11 laid out in a star shape and opening into a annular channel 12. In this case, the central circular cavity 10, the channels 11 laid out in a star shape, and the annular channel 12, can all be describes as the cavity, and also play the role of a means for diffusing the steam to the diffusion channels 9. Naturally, the cavity or cavities can also assume other forms. These different elements 10, 11, 12 are created on the inner face 3₁ of the bottom 3 of the receptacle 1 and in the example illustrated are open onto the internal volume 4. As illustrated in FIG. 2, the steam therefore circulates along the inner face 21 of the wall 2.

In the examples illustrated in the figures, the different diffusion channels 9 are connected to the annular channel 12. It can also be seen that the liquid reserve can be placed only in the circular cavity 10 for example, or can come in the form of a saturated sponge, as illustrated in FIG. 2. It is also possible to partially or totally fill the central circular cavity 10, the channels 11 laid out in a star shape, and the annular channel 12, with the desired quantity of liquid, which then all play the role of the cavity 6, as illustrated in FIG. 5.

In order to further facilitate the circulation of steam along the channels, the receptacle 1 advantageously consists of a more-or-less tapered body flaring outward from the bottom 3. In this case, the diffusion channels 9 will be located advantageously, as illustrated in FIG. 1 in particular, parallel to the generatrix line of the tapered body of the receptacle 1. The diffusion channels 9 can extend from the bottom 3 as far as the top edge 13 of the receptacle 1. Now when the receptacle 1 is intended to be capped, it can be advantageous, as illustrated in FIG. 7, for the diffusion channels 9 not to extend fully as far as the top edge 13, in order to create a passage for the steam at the top of the receptacle 1.

According to a preferred variant, the diffusion channels 9 can take the form of half-cylinders that are open to the internal volume 4 of the receptacle 1. These half-cylinders preferably have a diameter of between 3 and 10 mm, and advantageously of the order of 7 mm. As a general rule, the consistency of the food preparation 5 is such that the latter penetrates little or no distance into the cavity 6 or into the diffusion channels 9. The number of diffusion channels 9, spread around the periphery of the receptacle 1, is chosen to ensure even circulation and to favour even cooking of the food preparation 5, thus allowing the cooking time to be reduced. It is possible, for example, to have 10 to 20 diffusion channels 9 along the wall 2 of the receptacle 1.

In contrast to the receptacle holding the food preparation, used in the technique of the prior art described above, neither the bottom 3 nor the wall 2 of the receptacle 1 is perforated. The generated steam is therefore contained inside the receptacle. The receptacle 1 is self-supporting, which means that it retains its form when set down, in contrast to a sachet made of flexible film, for example, which is completely soft and loses its shape when set down. It is therefore advantageously created from a material that has a certain rigidity. The material constituting this receptacle 1 can be a polymer, for example, such as polypropylene or polyethylene. In certain cases, it can be advantageous for the receptacle 1 to be in a material that is impermeable to gas. As examples of such material, it is possible to mention a mixture of XPS/EVOH/PE or XPP/EVOH/PE (where XPS=expanded polystyrene, EVOH=ethylene vinyl alcohol, XPP=expanded polypropylene, and PE=polyethylene). The diffusion channels 9 and the cavity 6 will advantageously be moulded directly in the peripheral wall 2 and the bottom 3 respectively of the receptacle 1.

According to a particularly advantageous embodiment like that illustrated in the figures, the diffusion channels 9 are arranged so that they form ribs on the outer face 2₂ of the peripheral wall 2 of the receptacle 1. Likewise, the cavity 6, and where appropriate the means of connection to the diffusion channels 9 are arranged to project from the outer face 3₂ of the bottom 3 of the receptacle 1. However, the outer face 3₂ of the bottom 3 of the receptacle 1 will preferably constitute a stable seating surface for the receptacle 1.

The receptacle 1 is intended to be associated with an external envelope to form a pack I that will allow comfortable handling directly after the cooking operation. The outer envelope will play the role of thermal barrier and allow the user to grasp the pack I without burning himself or herself, when the pack I is removed from a microwave oven and contains a hot food preparation. The outer envelope can also play the role of support for information that can be printed directly on the envelope or placed on a label that is affixed to the envelope.

In a preferred manner, a space exists between at least a part of the outer face 2₂ of the peripheral wall 2 of the receptacle 1 and the inner face of the peripheral wall of the outer envelope, where this space plays the role of a thermal barrier. Thus, after cooking, the pack I can be handled comfortably, while the food preparation, placed inside the pack I, is hot.

The means can be provided for maintaining at least one part of the outer face 2₂ of the peripheral wall 2 of the receptacle 1 at a distance in relation to the inner face of the peripheral wall of the outer envelope, such as spacing elements created on the inside of the outer envelope for example, or on the outside of the inner receptacle 1. Use is made advantageously of a receptacle 1 that has spacing means on the outer face 2₂ of its peripheral wall 2. It is possible to use a receptacle 1, like that represented in FIGS. 1 and 3 in particular, in which the diffusion channels 9 constitute ribs on the outer face 2₂ of the wall 2 of the receptacle, where these ribs play the role of spacing means. In this case, the channels form protuberances on the outer face 2₂ of the wall 2 of the receptacle 1, and the wall of the receptacle 1 and that of the envelope will be in contact only at the level of the diffusion channels 9. It can also be arranged that there is virtually no point of contact, by the addition of other spacing means.

The outer envelope can assume different forms and shapes.

According to a first variant, represented FIGS. 4 to 6, this outer envelope is composed of an outer container 22, or can come in the form of a tub or open bowl. In the example illustrated, the body of the receptacle is of tapered form. This outer container 22 will accommodate a receptacle 1, as described above, which is therefore called the inner receptacle 1. The receptacle 1 is positioned inside the outer container 22 and fits inside the latter. It is therefore the outer container 22 that is directly handled by people during the packaging, preservation, cooking and consumption stages.

Advantageously, the receptacle 1 is equipped with means of support on the container 22. These means of support can take the form of studs or of a peripheral ring created from the outer face 2₂ of the wall 2 of the receptacle 1, and making contact with the inner face 23₁ of the wall 23 of the container 22.

According to a variant illustrated in FIGS. 2 and 6, as the means of support, the receptacle 1 can include a small collar 24 extending around its circumference. The said small collar 24 can then make contact with a shoulder 25 created in the outer container 22.

Similarly, it will be advantageous for the outer face 3₂ of the bottom 3 of the receptacle 1 to be, at least in part, held at a distance from the inner face 26₁ from the bottom 26 of the outer container 22. It is possible, for example, to use feet created on the bottom 3 of the receptacle 1, in order to keep it a few millimetres distant from the bottom 26 of the container 22. The distance can also be achieved by means of the small collar 24 and the shoulder 25. In this case, the distance between the bottom 26 of the outer container 22 and the shoulder 25 is slightly greater than the existing distance between the bottom 3 of the receptacle 1 and the small collar 24.

In addition, it is preferable for the receptacle 1 to be fitted within the container 22 in such a tight manner as to ensure the retention of the receptacle 1 in the container 22 by friction. This tight fit can be achieved, as illustrated in FIG. 6, with a small collar 24, where the outside diameter of the small collar 24 more-or-less matches the circumference of the container 22 at the level of the shoulder 25.

Once filled with the food preparation that one desires to package, the pack I is generally closed by any appropriate means. Closure can be achieved directly on the receptacle 1 or on the outer container 22. The outer container 22 can be closed with a lid. Where a food preparation that has to undergo a final stage of steam cooking in a microwave oven, the lid will preferably have at least one orifice that is intended, in a first stage, to allow removal of the excess steam generated during the cooking stage in a microwave oven.

It is also preferably possible to fit a sealing membrane 27 on the receptacle 1 or on the outer container 22. In particular, it is possible to use a sealing membrane, applied by thermo-sealing in particular, or it can take the form of a transparent film aesthetic reasons. FIGS. 4 and 5 show the case in which a sealing membrane is used. In FIGS. 4 and 5, it is the outer container that is sealed by a membrane and the top edge 28 of the container 22 is then to form an attachment surface for the sealing membrane. As shown in FIG. 5, the sealing membrane will be pierced or slightly raised before cooking in a microwave oven. In the case where it is a receptacle 1 that is sealed by a membrane, the top edge 13 of the receptacle 1 is then extended into a support surface for the sealing membrane. In particular, this support surface can be the small collar 24.

The container 22 can be made from an insulating material such as expanded polystyrene or a microfluted or nanofluted cardboard. When the packaging is completed by closure of the container 22, in order to allow packaging in a modified atmosphere, the material constituting the container 22 will advantageously be chosen to be impermeable to gases, and will be an XPS/EVOH/PE or XPP/EVOH/PE mixture for example.

According to another variant, illustrated in FIG. 7, the outer envelope can take the form of a sleeve 30 placed about the peripheral wall 2 of the receptacle 1. The sleeve 30 is most often attached to the receptacle 1, and the attachment can be achieved by glueing for example, or indeed the sleeve can be directly moulded onto the outer face 2₂ of the wall 2 of the receptacle 1. The sleeve can be in a cardboard with heat-insulation properties, such as a microfluted or nanofluted cardboard. It is also possible to use expanded polystyrene.

As shown in FIG. 7, it is therefore the receptacle 1 that is directly closed, with a sealing membrane for example. The latter has then a support surface for the sealing membrane, like a small collar. To allow packaging in a modified atmosphere, in this case the receptacle will be made from a material that is impermeable to gases, as described previously.

The pack I according to the invention has several advantages. In fact this pack, allows the pack to be handled, as well as preservation, cooking and consumption of the food preparation for which it is intended. The consumer will then be able to perform the final stage of steam cooking in a microwave oven directly in the pack I. In the case in which the closure of the pack is achieved by a sealing membrane, the said sealing membrane will be raised slightly in order to allow the steam generated. during the heating process to escape, and thus to avoid excessive pressure developing inside the pack.

The different channels 9 open onto the internal volume 4 of the receptacle 1, which are located along the outer wall 2 of the receptacle 1 so as to allow rapid diffusion of the steam created by the microwave action inside the food preparation 5, and to allow even cooking of the latter. To some extent, the steam is channelled into the receptacle 1. As a consequence, the thawing times and steam cooking times are very short. The result is an excellent quality of the food preparation, without any trace of drying out.

Finally, one of the essential advantages of the invention is that the consumer can eat the food preparation directly from its pack I once it has been cooked. In fact in all cases, the outer envelope is at a temperature that is acceptable, since it is acting as a thermal barrier, assisted where appropriate by a space between the receptacle 1 and the latter, which provides an additional insulating barrier.

The pack I according to the invention can therefore be used for the packaging, the preservation, the cooking and the consumption of a food preparation, and in particular, a food preparation that is intended to undergo a final stage of steam cooking in a microwave oven.

The subject of the invention is also a food product that includes a food preparation packaged in a pack as described above. The food preparation, which is intended to undergo a final stage of steam cooking in a microwave oven, is placed inside the receptacle 1, with a liquid reserve being placed in the cavity 6 provided for this purpose, the whole then being sealed, preferably hermetically, for preservation in cool or frozen conditions.

In particular, the food preparation will be composed of foodstuffs mixed with a hydrated sauce, in particular, of partially-cooked pasta that is mixed thoroughly with a hydrated sauce.

By food pasta, is meant pasta for culinary consumption and capable of taking various forms of the noodle, tagliatelli, spaghetti or other type. Before being pre-cooked, this pasta can be in dry form or in the form of fresh pasta. Pre-cooking is performed according to the conventional techniques for the cooking of pasta, which are well known to those skilled in the art. Advantageously, pre-cooking is performed by plunging the pasta into a large volume of boiling water. In the sense of the invention, the pasta is partially cooked, meaning that it has not yet reached the degree of cooking in which it will be consumed. Advantageously, it will have been cooked for a period of less than about 15 to 50% of the time necessary for al dente cooking. Al dente cooking is known to everyone, and refers to the cooking of pasta that is ready to eat but still retains at its core a very small uncooked part, so that the pasta thus cooked feels firm in the mouth. For each type of pasta, there therefore exists an al dente cooking time. The pre-cooked pasta employed in the method according to the invention can therefore not be consumed directly, since its cooking has been interrupted. Now during the pre-cooking stage, the pasta will have absorbed a certain quantity of water. However, it must still undergo a later cooking stage in order to reach the desired cooking state. During this later cooking stage, it will absorb the additional quantity of water necessary for its to reach the desired consistency and hydration.

By hydrated sauce is meant a preparation containing a certain quantity of water, and of liquid or semi-liquid consistency, in contrast to a dehydrated sauce that comes in dry form. This sauce has two essential functions, namely to supply at least one part of the water necessary for the additional hydration of the pre-cooked pasta during the cooking process in a microwave oven, and to give the pasta the desired taste. The sauce preferably has a consistency that is sufficiently thick to cause it to adhere to the pasta after mixing and thus to coat the pasta. This is why it is indicated that the pasta should be mixed thoroughly with the hydrated sauce. This hydrated sauce preferably serves as a coating sauce and after mixing is in intimate contact with each piece of pasta. Under the effect of the microwaves, the hydrated sauce thus enables steam to be generated very close to the pasta. This steam will be absorbed by the pasta, which will then swell during the final cooking stage in a microwave oven, to bring it to the optimum state for consumption.

The hydrated sauce can contain different elements of the aromatic, vegetable, fat or protein type, such as pieces of fish, meat, or shellfish, according to the flavour desired. In all cases, the hydrated sauce contains a certain quantity of water. Advantageously, the hydrated sauce contains a quantity of water that is at least equal to the additional quantity of water that the pre-cooked pasta would absorb in the context of al dente cooking. According to another variant, it is possible to consider that this sauce is super-hydrated in relation to a sauce that is designed to be mixed with pasta cooked al dente. By a “sauce designed to be mixed with pasta cooked al dente”, is meant a sauce that is ready for use, as available in shops for example, and that is generally consumed with pasta that is cooked directly for immediate consumption. Hydrated sauce preferably refers to a sauce that is designed to be mixed with pasta cooked al dente, to which has been added a percentage by weight of 15 to 45% of water, and preferably between 20 and 30%. This addition of extra water can obviously be effected by means of any aqueous liquid, capable of taking various forms, such as chicken stock, wine, coconut milk, etc. In particular, this addition of extra water will correspond approximately to the quantity of additional water that the pasta would absorb in the context of al dente cooking.

The mixture intended to be cooked by micro-steam in a microwave oven advantageously contains a percentage by weight of hydrated sauce, in relation to food pasta, of between 50 and 100%.

According to one implementation variant, not only suitable for preparations based on food pasta in sauce but also for any type of foodstuff in sauce, one part of the sauce, called the sauce reserve, is placed at the bottom of the receptacle 2, in the cavity 6 provided for this purpose, the remainder of the sauce being mixed intimately with the foodstuffs. In fact it has been observed that, in the case of sauce-based food preparations, such as pasta, when the totality of the sauce is mixed with the pasta, a non-stable state of the pasta is reached over time, meaning that the pasta progressively absorbs the sauce and softens. The mixture becomes drier since a part of the sauce will have been absorbed by the pasta. This phenomenon is accentuated in frozen products that are used a few days (generally between one and five) after defrosting. In fact the change in the structure of the molecules of the pasta after freezing accentuates this phenomenon.

By dividing the sauce between a portion located at the bottom of the receptacle 2 and a portion mixed with the pasta, one gets a visual and organoleptic result, after cooking by microwave, of a food preparation according to the invention in the fresh, frozen or defrosted state, regardless of the day of consumption, that is comparable to that which would be obtained with a food preparation that has just been prepared.

In particular, the weight of sauce, located to the bottom of the receptacle 2, which then plays the role of a liquid 7, will represent from 50 to 80% of the total weight of the sauce present in the receptacle 2, the remainder, called the coating sauce, being mixed with the foodstuffs. Most often, the volume of the sauce reserve exceeds the volume of the cavity or cavities located at the bottom of the receptacle 2, like that illustrated in FIG. 8. In this case, the cavity or cavities, which can take the form of channels for example, allow to the steam generated from the sauce reserve to diffuse via the diffusion channels 9 created in the walls of the receptacle 2. In order to facilitate the emission of steam from the bottom to the top of the receptacle, the sauce, located at the bottom of the receptacle, advantageously contains a larger proportion of water than the sauce mixed with the foodstuffs. The proportion of water varies according to the nature of the sauce. In particular, the sauce, placed at the bottom, preferably contains a percentage by weight of water of between 10 and 30% more than that of the sauce directly mixed with the foodstuffs. The coating sauce and the sauce reserve placed at the bottom of the container 2 advantageously both contain, in addition to the quantity of water present in the ready-to-use sauces, a quantity of water at least equal to the quantity of water that the pre-cooked pasta would absorb in the context of al dente cooking. The coating sauce and the sauce placed at the bottom of the container contain the same ingredients and differ only by the quantity of water present.

By way of an example, in the case of a pasta-based preparation, for a sauce of the Neapolitan type, the sauce placed at the bottom of the receptacle 2 will contain between 20 and 30% more water in relation to the coating sauce, and for a cream-based sauce, the sauce placed at the bottom will contain between 10 and 20% more water in relation to the coating sauce.

In addition, it can be advantageous to limit the percentage by weight of water in the coating sauce, and to arrange that the latter does not exceed a corresponding weight of 20 to 25% of the weight of pasta present in the preparation. The swelling of the foodstuffs by the absorption of water, and in particular by the pasta, directly in contact with the coating sauce, will thus be limited.

In this implementation variant, prior to cooking or during the cooking process, it is necessary to mix the food preparation coated with a part of the sauce with that placed to the bottom of the container 2.

In particular, in the case of a food preparation that is still frozen, the pack I is deposited, frozen and closed, in a microwave oven. A first cooking stage consists of defrosting the sauce and bringing it to the boil with the release of steam, so that the latter travels along the channels in the receptacle. By way of an illustration, in a microwave oven with a cooking power of 2100 W, this stage lasts for approximately 1 minute. The phenomenon observed is due to the behaviour of the microwaves, which are first attracted by the sauce at the bottom, because of its high water and fat content. Thus the microwaves do not affect the pasta and therefore do not cook it at the surface. At the end of this stage, the pack I is shaken in order to mix the pasta with the totality of the sauce. Cooking is resumed after the receptacle has been opened slightly, for 1 minute, in the same oven, to reach a core temperature of more than 70° C.

In order to facilitate the stirring process and the second stage, a sealing membrane with micro-perforations can be used. This does not need to be peeled off for the cooking process, since it allows the steam to escape, but not the liquid.

Thus, in the foregoing example, the food preparation is cooked in less than 2 minutes, with the contents of the pack coming directly from the freezer. In a 1400 watt oven, this time is of the order of 3 minutes. This period is less than that generally recommended for the individual frozen portions sold in the shops.

In the case of defrosted products and fresh products, the mixing will be effected before the start of the cooking process. The cooking time will also be chosen to as to arrive preferably at a temperature of more than 70° C. at the core of the food preparation.

In this implementation variant, the foodstuffs covered with the coating sauce can be deposited directly onto the sauce reserve placed at the bottom of the receptacle 2. This sauce reserve can have been frozen beforehand.

It is also possible to use separation means between the foodstuffs mixed with the coating sauce and the liquid reserve placed to the bottom of the receptacle 2. These separation means are particularly useful when the sauce reserve, which is located at the bottom, is liquid (fresh or defrosted products). The pasta that is in contact with the reserve may tend to penetrate into the sauce however. This phenomenon can detract from to the evenness of the final cooking.

In order to ensure good separation, it is possible to use the following for example:
a thin layer of gelatine deposited on the bottom sauce at the moment of packaging, which will melt and mix with the pasta to the time of cooking,
a separating sheet, in polypropylene for example, or in another material that will tolerate microwaves, which will be placed above the sauce reserve located at the bottom. This sheet can be held in the receptacle by a clipping action. This sheet will have perforations of sufficient diameter to allow passage of the sauce during the sauce/pasta mixing stage, but sufficiently small to prevent passage of the pasta. As an example, in particular for a disk of 8 cm in diameter, it is possible to provide four to eight holes in the disk of between 1 and 2 cm in diameter.

In the case where the sauce reserve is dense and thick, the latter will constitute a natural barrier, and will oppose the penetration of the pasta.

Such separation techniques can also be used, where appropriate, in the case where the liquid placed at the bottom of the receptacle 2 is other than a portion of the sauce.

According to another implementation variant, it is also possible to place a liquid reserve in the cavity 6 such as water or flavoured water, then above this liquid reserve, at the bottom of the receptacle 2, a sauce reserve and, above this again, a mixture of foodstuffs and coating sauce. In this case, the liquid reserve and the sauce reserve will advantageously be separated by separating means such as a layer of gelatine, as described above, or indeed a separating sheet that includes small passages for diffusion of the steam. These passages can take the form of perforations, measuring 50 mm in diameter for example.

The food product according to the invention is thus made ready to use very rapidly and easily, and the result is a plate of pasta that is tasty and rich, and this is achieved with no unpleasant or other odours and is directly consumable with no need for transfer into another receptacle. Such a pack is therefore perfectly suitable for use in hotels, cafés, fast food outlets, sports or leisure clubs, and generally anyplace where catering services can be provided.

1. A receptacle (1) in a material that allows the passage of microwaves, intended to accommodate a food preparation (5) that has to undergo a final stage of steam cooking in a microwave oven, where this receptacle (1) includes a peripheral wall (2) and a bottom (3) forming an internal volume (4), characterised in that the bottom of the receptacle is unperforated and includes a cavity which is (6) intended to accommodate a liquid reserve, and in that the peripheral wall (2) of the receptacle (1) is equipped with a series of channels for diffusion (9) of the steam generated from the liquid (7) during the cooking stage in a microwave oven, with the said diffusion channels (9) being connected to the cavity (6) and to the internal volume (4) of the receptacle (1).

2. A receptacle (1) according to claim 1, characterised in that the connection between the cavity (6) and the diffusion channels (9) is provided by channels (11) in a star formation, connected to an annular channel (12) created on the inner face (3₁) of the bottom (3) of the receptacle (1).

3. A receptacle (1) according to claim 1, characterised in that it has a more-or-less tapered body, flaring outward from the bottom (3) of the receptacle.

4. A receptacle (1) according to claim 1, characterised in that the diffusion channels (9) are created so as to form ribs on the outer face (22) of the peripheral wall (2).

5. A receptacle (1) according to claim 1, characterised in that the cavity (6) is arranged to form a projection on the outer face (32) of the bottom (3).

6. A receptacle (1) according to claim 1, characterised in that it has a support surface for a sealing membrane.

7. A receptacle (1) according to claim 1, characterised in that it includes support means on an outer container in which the receptacle is intended to be inserted.

8. A receptacle (1) according to claim 1, characterised in that its top edge (13) is extended into a small collar (24).

9. A receptacle (1) according to claim 1, characterised in that neither its peripheral wall nor its bottom is perforated.

10. A receptacle (1) according to claim 1, characterised in that the material constituting the receptacle is impermeable to gases.

11. A receptacle (1) according to claim 10, characterised in that the material constituting the first receptacle is an XPS/EVOH/PE or PPX/EVOH/PE mixture.

12. A receptacle (1) according to claim 1, characterised in that the material constituting the receptacle is in polypropylene or polyethylene.

13. A receptacle (1) according to claim 1, characterised in that the diffusion channels can take the form of a half-cylinder open to the internal volume (4) of the receptacle (1), preferably with a diameter of between 3 and 10 mm, and advantageously of the order of 7 mm.

14. A disposable pack (I) for a food preparation that is intended to undergo a final stage of steam cooking in a microwave oven, and which includes:
a receptacle (1) according to claim 1, and
an external envelope placed around the peripheral wall (2) of the receptacle (1) and acting as a thermal barrier.

15. A pack (I) according to claim 14, characterised in that the outer face (2₂2) of the peripheral wall (2) of the receptacle (1) is, at least in part, held at a distance from the inner face of the wall of the outer envelope.

16. A pack (I) according to claim 14, characterised in that the outer envelope is a container (22).

17. A disposable pack (I) according to claim 16, characterised in that the receptacle (1) has a small collar (24) extending around its circumference, with the said small collar and making contact with a shoulder (25) created in the container (22).

18. A disposable pack (I) according to claim 16, characterised in that the receptacle (1) is fitted within the container (22) in such a tight manner as to ensure the retention of the receptacle (1) in the container (22) by friction.

19. A disposable pack (I) according to claim 16, characterised in that the container (22) includes a support surface for a sealing membrane.

20. A disposable pack (I) according to claim 16, characterised in that the material constituting the container (22) is impermeable to gases.

21. A disposable pack (I) according to claim 20, characterised in that the material constituting the container (22) is a XPS/EVOH/PE or PPX/EVOH/PE mixture.

22. A disposable pack (I) according to claim 16, characterised in that the outer face (3₂) of the bottom (3) of the receptacle (1) is, at least in part, held at a distance from the inner face (26₁) of the bottom (26) of the container (22).

23. A pack (I) according to claim 14, characterised in that the outer envelope is a sleeve (30).

24. A pack (I) according to claim 23, characterised in that the sleeve (30) is in expanded polystyrene or in nanofluted or microfluted cardboard.

25. A food product, characterised in that it includes a food preparation (5) intended to undergo a final stage of steam cooking in a microwave oven, packaged, preferably hermetically, for preservation in cool or frozen conditions, in a pack (I) according to claim 14, with the said preparation being placed inside the receptacle (1), and in that a liquid reserve (7) is placed in the cavity (6) provided for this purpose created in the receptacle (1).

26. A food product according to claim 25, characterised in that the food preparation is composed of food pasta that is partially cooked and mixed thoroughly with a hydrated sauce.

27. A food product according to claim 25, characterised in that the food preparation is packaged in a modified atmosphere.

28. A food product according to claim 25, characterised in that the food preparation is packaged in frozen form.

29. A food product according to claim 25, characterised in that the pack (I) is closed by a sealing membrane positioned directly on the receptacle (1).

30. A food product according to claim 25, characterised in that the pack (I) is closed by means of a sealing membrane positioned on the envelope.

31. A food product according to claim 25, characterised in that a reserve of hydrated sauce containing, preferably, between 30 and 60% by weight of water, constitutes the liquid reserve.

32. A food product according to claim 31, characterised in that the volume of the hydrated sauce reserve is located at the bottom of the receptacle and exceeds the volume of the cavity (6).

33. A food product according to claim 31, characterised in that the reserve of hydrated sauce represents between 50 and 80% of the total weight of sauce present in the food product, with the remainder of sauce being mixed with the foodstuffs.

34. A food product according to claim 31, characterised in that the food preparation and the reserve of hydrated sauce are separated by separation means, advantageously composed of a layer of gelatine or of a perforated sheet.
